(19) United States
(12) Patent Application Publication
(10) Pub. No.: US 2011/0032488 A1
(43) Pub. Date: Feb. 10, 2011

(54) Projection Display Apparatus

(75) Inventors: Takaaki ABE, Osaka (JP); Masutaka INOUE, Osaka (JP); Susumu TANASE, Osaka (JP); Yoshinao HIRANUMA, Osaka (JP); Tomoya TERAUCHI, Osaka (JP); Masahiro HARAGUCHI, Osaka (JP)

Correspondence Address: NDQ&M WATCHSTONE LLP, 300 NEW JERSEY AVENUE, NW, FIFTH FLOOR, WASHINGTON, DC, 20001, US

(73) Assignee: SANYO ELECTRIC CO., LTD., Osaka (JP)

(21) Appl. No.: 12/845,319

(22) Filed: Jul. 28, 2010

(30) Foreign Application Priority Data
Jul. 28, 2009 (JP) 2009-175438

(51) Int. Cl. G03B 21/16; G03B 21/14

(52) U.S. Cl. 353/54; 353/85; 353/52

(57) ABSTRACT

A projection display apparatus includes: a light source, a light valve configured to modulate light emitted from the light source, a projection unit configured to project light emitted from the light valve, on a projection surface, and a valve controller configured to initialize the light valve in response to a drive-starting command to start driving the projection display apparatus; and a light-source controller configured to make the light source start operating when the valve controller finishes initialization of the light valve.

### CROSS REFERENCE TO RELATED APPLICATIONS

This application is based upon and claims the benefit of priority from prior Japanese Patent Application No. 2009-175438, filed on Jul. 28, 2009; the entire contents of which are incorporated herein by reference.

### BACKGROUND OF THE INVENTION

1. Field of the Invention

The present invention relates to a projection display apparatus which includes; a solid light source, a light valve configured to modulate light emitted from the solid light source, and a projection unit configured to project light emitted from the light valve on a projection plane.

2. Description of the Related Art

There has been known a projection display apparatus including a light source, a light valve configured to modulate light emitted from the light source and a projection unit configured to project the image light emitted from the light valve onto a projection surface.

If data to be reproduced (hereafter, “reproduction data”) contain no image data, that is, if the reproduction data are audio data, it is not necessary to start up the light source at the time of starting the projection display apparatus. In contrast, if the shutter of the projection lens is opened by the user, the reproduction data are expected to contain image data. To address this situation, proposed is a method of starting up a projection display apparatus without checking whether the reproduction data contain image data or not if the shutter of the projection lens is opened by the user (see Japanese Patent Application Publication No. 2008-299274). Since this method does not check whether the reproduction data actually contain image data or not, the light source can be started up quickly.

However, how to start up the light source quickly is the sole focus of the method of Patent Literature 1. The method pays no attention to the control of the light valve. According to the method, there is possibility that light emitted from the light source may enter the light value in an uninitialized state, and that the light valve may emit undesired light.

### SUMMARY OF THE INVENTION

A projection display apparatus according to first aspect includes: a light source; a light valve configured to modulate light emitted from the light source; a projection unit configured to project light emitted from the light valve, on a projection surface; a valve controller configured to initialize the light valve in response to a drive-starting command to start driving the projection display apparatus; and a light-source controller configured to make the light source start operating when the valve controller finishes initialization of the light valve.

In the first aspect, the projection display apparatus further includes: a temperature adjuster configured to adjust a temperature of the light source; a temperature-adjustor controller configured to make the temperature adjustor start operating in response to the drive-starting command; and a temperature sensor configured to detect an indicator temperature that is used as an indicator for the temperature of the light source. The light-source controller makes the light source start operating on condition that the indicator temperature detected by the temperature sensor is within a predetermined temperature range.

In the first aspect, the temperature adjustor includes a coolant jacket in which a liquid medium circulates and which is attached to the light source. The temperature sensor detects a temperature of the liquid medium supplied to the coolant jacket, as the indicator temperature.

In the first aspect, the projection display apparatus further includes an intrusion-determining portion configured to determine whether or not an intruding object exists on or near an optical passage of light emitted from the projection unit. When the intrusion-determining portion determines that no intruding object exists on or near the optical passage, the light-source controller makes the light source start operating.

In the first aspect, the projection display apparatus includes: a light-blocking shutter provided at a light-emitting side of the light source; and a light-blocking-shutter controller configured to initialize the light-blocking shutter by closing the light-blocking shutter in response to the drive-start command. When the light-blocking-shutter controller finishes initialization of the light-blocking shutter, the light-source controller makes the light source start operating.

### BRIEF DESCRIPTION OF THE DRAWINGS

FIG. 1 is a perspective view illustrating a projection display apparatus 100 according to a first embodiment of the invention.

FIG. 2 is a side view illustrating the projection display apparatus 100 according to the first embodiment.

FIG. 3 is a diagram illustrating a light-source unit 110 according to the first embodiment.

FIG. 4 is a diagram illustrating a color separation-synthesis unit 140 and a projection unit 150 according to the first embodiment.

FIG. 5 is a diagram illustrating a configuration of a control unit 600 according to the first embodiment.

FIG. 6 is a flowchart to describe an operation of the control unit 600 according to the first embodiment.

FIG. 7 is a diagram illustrating a control unit 600 according to a second embodiment of the invention.

FIG. 8 is a flowchart to describe an operation of the control unit 600 according to the second embodiment.

FIG. 9 is a diagram illustrating a control unit 600 according to a third embodiment of the invention.

FIG. 10 is a flowchart to describe an operation of the control unit 600 according to the third embodiment.

FIG. 11 is a diagram illustrating a projection unit 150 according to a fourth embodiment of the invention.

FIG. 12 is a diagram illustrating a control unit 600 according to the fourth embodiment.

FIG. 13 is a flowchart to describe an operation of the control unit 600 according to the fourth embodiment.

### DETAILED DESCRIPTION OF THE EMBODIMENTS

Hereinafter, a projection display apparatus according to embodiments of the present invention will be described with reference to the drawings. In the following description of the drawings, the same or similar reference signs are attached to the same or similar units and portions.

It should be noted that the drawings are schematic and ratios of dimensions and the like are different from actual ones. Therefore, specific dimensions and the like should be determined in consideration of the following description. Moreover, it is needless to say that the drawings also include portions having different dimensional relationships and ratios from each other.

### First Embodiment

### (Configuration of Projection Display Apparatus)

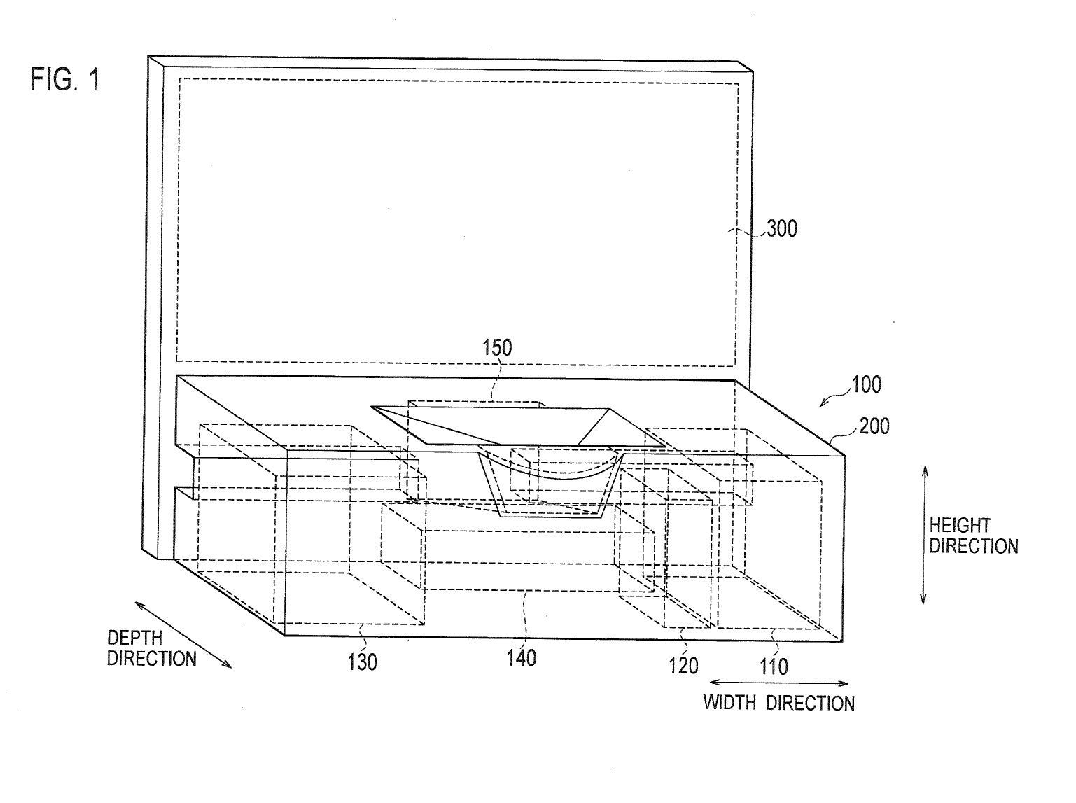

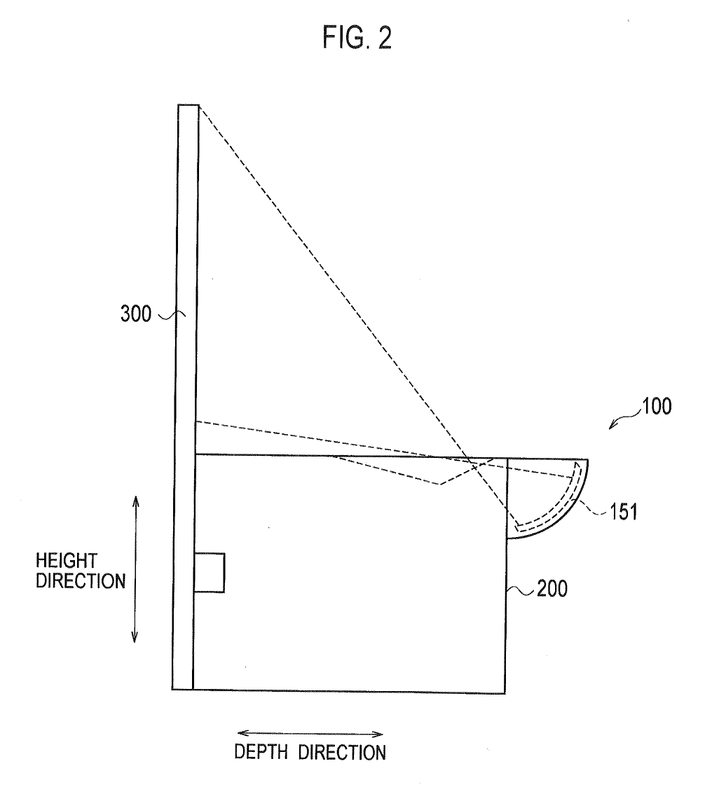

Hereinafter, a configuration of a projection display apparatus according to a first embodiment will be described with reference to FIGS. 1 and 2. FIG. 1 is a perspective view of a projection display apparatus 100 according to the first embodiment. FIG. 2 is a view of the projection display apparatus 100 according to the first embodiment when viewed from side.

As shown in FIGS. 1 and 2, the projection display apparatus 100 includes a housing case 200 and is configured to project an image on a projection plane 300. The projection display apparatus 100 is arranged along a first placement surface (a wall surface 420 shown in FIG. 2) and a second placement surface (a floor surface 410 shown in FIG. 2) substantially orthogonal to the first placement surface.

In the first embodiment, a horizontal direction parallel to the projection plane 300 is referred to as “a width direction”, a orthogonal direction to the projection plane 300 is referred to as “a depth direction”, and an orthogonal direction to both of the width direction and the depth direction is referred to as “a height direction”.

The housing case 200 has a substantially rectangular parallelepiped shape. The size of the housing case 200 in the depth direction and the size of the housing case 200 in the height direction are smaller than the size of the housing case 200 in the width direction. The size of the housing case 200 in the depth direction is almost equal to a projection distance from a concave mirror 151 which is a reflection mirror to the projection plane 300. In the width direction, the size of the housing case 200 is almost equal to the size of the projection plane 300. In the height direction, the size of the housing case 200 is determined depending on a position where the projection plane 300 is provided.

The housing case 200 houses a light source unit 110, a power supply unit 120, a cooling unit 130, a color separating-combining unit 140, and a projection unit 150.

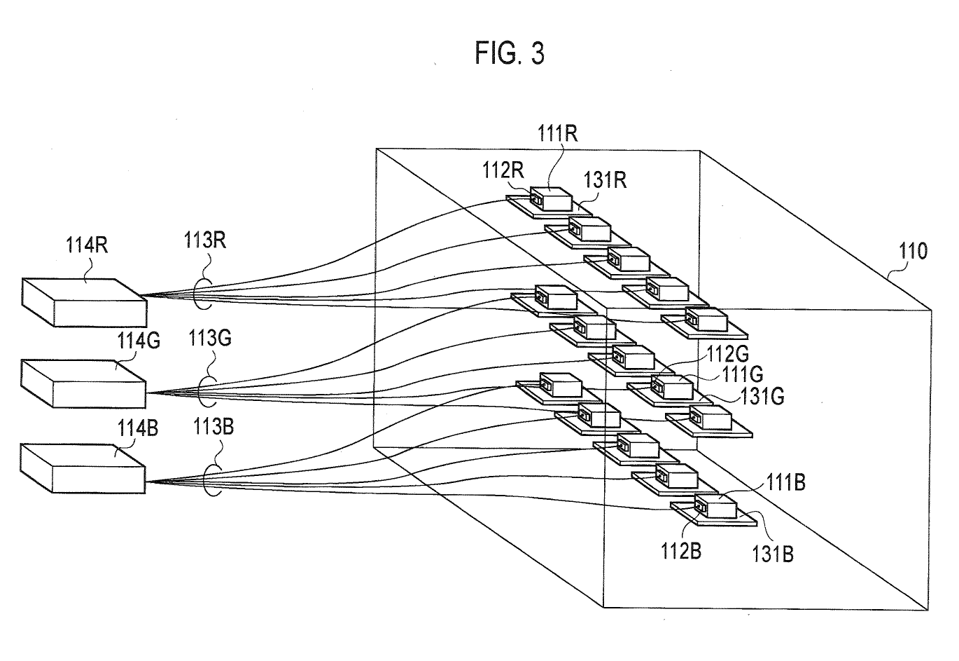

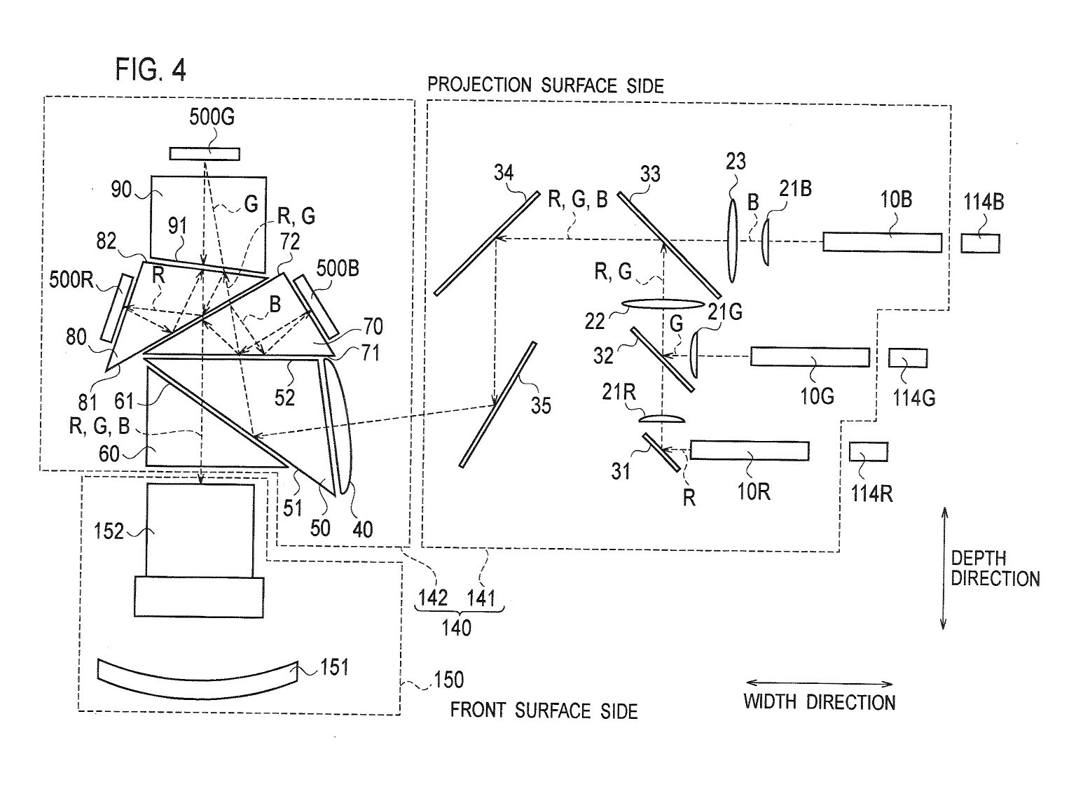

The light source unit 110 is a unit including multiple solid light sources (solid light sources 111 shown in FIG. 3). Each of the solid light sources ill is a light source such as a laser diode (LD). In the first embodiment, the light source unit 110 includes red solid light sources (red solid light sources 111R shown in FIG. 3) configured to emit red component light R, green solid light sources (green solid light sources 111G shown in FIG. 4) configured to emit green component light G, and blue solid light sources (blue solid light sources 111B shown in FIG. 3) configured to emit blue component light B. The light source unit 110 will be described in detail below.

The power supply unit 120 is a unit to supply power to the projection display apparatus 100. The power supply unit 120 supplies power to the light source unit 110 and the cooling unit 130, for example.

The cooling unit 130 is a unit to cool the multiple solid light sources provided in the light source unit 110. Specifically, the cooling unit 130 cools each of the solid light sources by cooling jackets (cooling jackets 131 shown in FIG. 3) on which the solid light source is mounted. Note that, the cooling unit 130 is an example of “a temperature adjuster” which adjusts a temperature of each of the solid light sources 111.

The cooling unit 130 may be configured to cool the power supply unit 120 and a light valve (DMDs 500 shown in FIG. 4) in addition of the solid light sources.

The color separating-combining unit 140 combines the red component light R emitted from the red solid light sources, the green component light G emitted from the green solid light sources, and the blue component light B emitted from the blue solid light sources. In addition, the color separating-combining unit 140 separates combined light including the red component light R, the green component light G, and the blue component light B, and modulates the red component light R, the green component light G, and the blue component light B. Moreover, the color separating-combining unit 140 recombines the red component light R, the green component light G, and the blue component light B, and thereby emits image light to the projection unit 150. The color separating-combining unit 140 will be described in detail later.

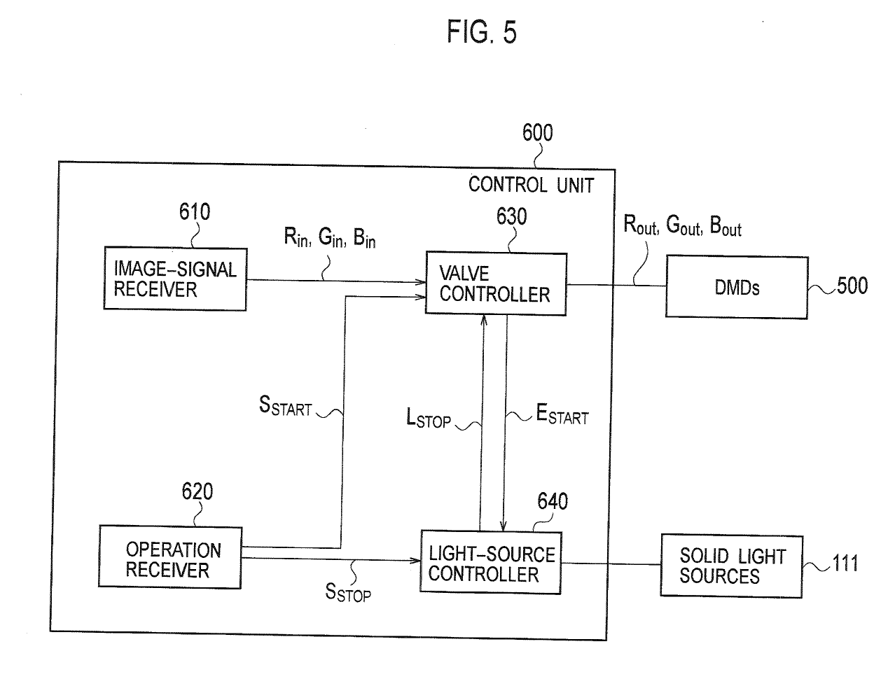

The projection unit 150 projects the light (image light) outputted from the color separating-combining unit 140 on the projection plane 300. Specifically, the projection unit 150 includes a reflection mirror (a concave mirror 151 shown in FIG. 5) configured to reflect the light, outputted from the projection lens group, to the projection plane 300, and a projection lens group (a projection lens group 152 shown in FIG. 4) configured to project the light outputted from the color separating-combining unit 140 on the projection plane 300. The projection unit 150 will be described in detail later.

### (Configuration of Light Source Unit)

Hereinafter, a configuration of the light source unit according to the first embodiment will be described with reference to FIG. 3. FIG. 3 is a view showing the light source unit 110 according to the first embodiment.

As shown in FIG. 3, the light source unit 110 includes multiple red solid light sources 111R, multiple green solid light sources 111G and multiple blue solid light sources 111B.

The red solid light sources 111R are red solid light sources, such as LDs, configured to emit red component light R as described above. Each of the red solid light sources 111R includes a head 112R to which an optical fiber 113R is connected.

The optical fibers 113R connected to the respective heads 112R of the red solid light sources 111R are bundled by a bundle unit 114R. In other words, the light beams emitted from the respective red solid light sources 111R are transmitted through the optical fibers 113R, and thus are gathered into the bundle unit 114R.

The red solid light sources 111R are mounted on respective cooling jackets 131R. For example, the red solid light sources 111R are fixed to respective cooling jackets 131R by screwing. The red solid light sources 111R are cooled by respective cooling jackets 131R. Inside the cooling jackets 131R, a path (Not shown) where cooling medium passes through is formed, and the cooling medium is outputted into the path from the cooling unit 130. Thereby, the red solid light sources 111R are cooled by the cooling jackets 131R. Note that, the cooling medium is an example of “liquid medium”, and the cooling jacket 131R is an example of “a coolant jacket”.

The green solid light sources 111G are green solid light sources, such as LDs, configured to emit green component light G as described above. Each of the green solid light sources 111E includes a head 112G to which an optical fiber 113G is connected.

The optical fibers 113G connected to the respective heads 112G of the green solid light sources 111G are bundled by a bundle unit 114G. In other words, the light beams emitted from all the green solid light sources 111G are transmitted through the optical fibers 113G, and thus are gathered into the bundle unit 114G.

The green solid light sources 111G are mounted on respective cooling jackets 131G. For example, the green solid light sources 111G are fixed to respective cooling jackets 131G by screwing. The green solid light sources 111G are cooled by respective cooling jackets 131G. Inside the cooling jackets 131G, a path (Not shown) where cooling medium passes through is formed, and the cooling medium is outputted into the path from the cooling unit 130. Thereby, the green solid light sources 111G are cooled by the cooling jackets 131G. Note that, the cooling jacket 131G is an example of “a coolant jacket”.

The blue solid light sources 111B are blue solid light sources, such as LDs, configured to emit blue component light B as described above. Each of the blue solid light sources 111B includes a head 112B to which an optical fiber 113B is connected.

The optical fibers 113B connected to the respective heads 112B of the blue solid light sources 111B are bundled by a bundle unit 114B. In other words, the light beams emitted from all the blue solid light sources 111B are transmitted through the optical fibers 113B, and thus are gathered into the bundle unit 114B.

The blue solid light sources 111B are mounted on respective cooling jackets 131B. For example, the blue solid light sources 111B are fixed to respective cooling jackets 131B by screwing. The blue solid light sources 111B are cooled by respective cooling jackets 131B. Inside the cooling jackets 131B, a path (Not shown) where cooling medium passes through is formed, and the cooling medium is outputted into the path from the cooling unit 130. Thereby, the blue solid light sources 111B are cooled by the cooling jackets 131B. Note that, the cooling jacket 131B is an example of “a coolant jacket”

### (Configurations of Color Separating-Combining Unit and Projection Unit)

Hereinafter, configurations of the color separating-combining unit and the projection unit according to the first embodiment will be described with reference to FIG. 4. FIG. 4 is a view showing the color separating-combining unit 140 and the projection unit 150 according to the first embodiment. The projection display apparatus 100 based on the DLP (Digital Light Processing) technology (registered trademark) is illustrated in the first embodiment.

As shown in FIG. 4, the color separating-combining unit 140 includes a first unit 141 and a second unit 142. Although not shown in the drawings, the color separating-combining unit 140 has various members including a housing of the first unit 141 and the second unit 142. Specifically, note that various members are provided around the DMD 500.

The first unit 141 is configured to combine the red component light R, the green component light G, and the blue component light B, and to output the combine light including the red component light R, the green component light G, and the blue component light B to the second unit 142.

Specifically, the first unit 141 includes multiple rod integrators (a rod integrator 10R, a rod integrator 10G, and a rod integrator 10B), a lens group (a lens 21R, a lens 21G, a lens 21B, a lens 22, and a lens 23), and a mirror group (a mirror 31, a mirror 32, a mirror 33, a mirror 34, and a mirror 35).

The rod integrator 10R includes a light incident surface, a light output surface, and a light reflection side surface provided between an outer circumference of the light incident surface and an outer circumference of the light output surface. The rod integrator 10R uniformizes the red component light R outputted from the optical fibers 113R bundled by the bundle unit 114R. More specifically, the rod integrator 10R makes the red component light R uniform by reflecting the red component light R with the light reflection side surface.

The rod integrator 10G includes a light incident surface, a light output surface, and a light reflection side surface provided between an outer circumference of the light incident surface and an outer circumference of the light output surface. The rod integrator 10G uniformizes the green component light G outputted from the optical fibers 113G bundled by the bundle unit 114G. More specifically, the rod integrator 10G makes the green component light G uniform by reflecting the green component light G with the light reflection side surface.

The rod integrator 10B includes a light incident surface, a light output surface, and a light reflection side surface provided between an outer circumference of the light incident surface and an outer circumference of the light output surface. The rod integrator 10B uniformizes the blue component light B outputted from the optical fibers 113B bundled by the bundle unit 114B. More specifically, the rod integrator 10B makes the blue component light B uniform by reflecting the blue component light B with the light reflection side surface.

Incidentally, each of the rod integrator 10R, the rod integrator 10G, and the rod integrator 10B may be a hollow rod including a mirror surface as the light reflection side surface. Instead, each of the rod integrator 10R, the rod integrator 10G, and the rod integrator 10B may be a solid rod formed of a glass.

The lens 21R is a lens configured to make the red component light R substantially parallel so that the substantially parallel red component light R can enter a DMD 500R. The lens 21G is a lens configured to make the green component light G substantially parallel so that the substantially parallel green component light G can enter a DMD 500G. The lens 21B is a lens configured to make the blue component light B substantially parallel so that the substantially parallel blue component light B can enter onto a DMD 500B.

The lens 22 is a lens configured to cause the red component light and the green component light G to substantially form images on the DMD 500R and the DMD 500G, respectively, while controlling the expansion of the red component light R and the green component light G. The lens 23 is a lens configured to cause the blue component light B to substantially form an image on the DMD 500B while controlling the expansion of the blue component light B.

The mirror 31 reflects the red component light R outputted from the rod integrator 10R. The mirror 32 is a dichroic mirror configured to reflect the green component light G outputted from the rod integrator 10G, and to transmit the red component light R. The mirror 33 is a dichroic mirror configured to transmit the blue component light B outputted from the rod integrator 10B, and to reflect the red component light R and the green component light G.

The mirror 34 reflects the red component light R, the green component light G, and the blue component light B. The mirror 35 reflects the red component light R, the green component light G, and the blue component light B to the second unit 142. Here, FIG. 5 shows the configurations in a plan view for simplification of the description; however, the mirror 35 actually reflects the red component light R, the green component light G, and the blue component light B obliquely in the height direction.

The second unit 142 separates the red component light R, the green component light G, and the blue component light B from each other, and modulates the red component light R, the green component light G, and the blue component light B. Subsequently, the second unit 142 recombines the red component light R, the green component light G, and the blue component light B, and outputs the image light to the projection unit 150.

Specifically, the second unit 142 includes a lens 40, a prism 50, a prism 60, a prism 70, a prism 80, a prism 90, and multiple digital micromirror devices (DMDs: a DMD 500R, a DMD 500G and a DMD 500B).

The lens 40 is a lens configured to make the light outputted from the first unit 141 substantially parallel so that the substantially parallel light of each color component can enter the DMD of the same color.

The prism 50 is made of a light transmissive material, and includes a surface 51 and a surface 52. An air gap is provided between the prism 50 (the surface 51) and the prism 60 (a surface 61), and an angel (incident angle) at which the light outputted from the first unit 141 enters the surface 51 is larger than a total reflection angle. For this reason, the light outputted from the first unit 141 is reflected by the surface 51. On the other hand, an air gap is also provided between the prism 50 (the surface 52) and the prism 70 (a surface 71), and an angel (incident angle) at which the light outputted from the first unit 141 enters the surface 52 is smaller than the total reflection angle. Thus, the light reflected by the surface 51 passes through the surface 52.

The prism 60 is made of a light transmissive material, and includes the surface 61.

The prism 70 is made of a light transmissive material, and includes a surface 71 and a surface 72. An air gap is provided between the prism 50 (the surface 52) and the prism 70 (the surface 71), and an angle (incident angle) at which each of the blue component light B reflected by the surface 72 and the blue component light B outputted from the DMD 500B enters the surface 71 is larger than the total reflection angle. Accordingly, the blue component light B reflected by the surface 72 and the blue component light B outputted from the DMD 500B are reflected by the surface 71.

The surface 72 is a dichroic mirror surface configured to transmit the red component light R and the green component light G and to reflect the blue component light B. Thus, in the light reflected by the surface 51, the red component light R and the green component light G pass through the surface 72, but the blue component light B is reflected by the surface 72. The blue component light B reflected by the surface 71 is again reflected by the surface 72.

The prism 80 is made of a light transmissive material, and includes a surface 81 and a surface 82. An air gap is provided between the prism 70 (the surface 72) and the prism 80 (the surface 81). Since an angle (incident angle) at which each of the red component light R passing through the surface 81 and then reflected by the surface 82, and the red component light R outputted from the DMD 500R again enters the surface 81 is larger than the total reflection angle, the red component light R passing through the surface 81 and then reflected by the surface 82, and the red component light R outputted from the DMD 500R are reflected by the surface 81. On the other hand, since an angle (incident angle) at which the red component light R outputted from the DMD 500R, reflected by the surface 81, and then reflected by the surface 82 again enters the surface 81 is smaller than the total reflection angle, the red component light R outputted from the DMD 500R, reflected by the surface 81, and then reflected by the surface 82 passes through the surface 81.

The surface 82 is a dichroic mirror surface configured to transmit the green component light G and to reflect the red component light R. Hence, in the light passing through the surface 81, the green component light G passes through the surface 82, whereas the red component light R is reflected by the surface 82. The red component light R reflected by the surface 81 is reflected by the surface 82. The green component light G outputted from the DMD 500G passes through the surface 82.

Here, the prism 70 separates the blue component light B from the combine light including the red component light R and the green component light G by means of the surface 72. The prism 80 separates the red component light R and the green component light G from each other by means of the surface 82. In short, the prism 70 and the prism 80 function as a color separation element to separate the color component light by colors.

Note that, in the first embodiment, a cut-off wavelength of the surface 72 of the prism 70 is set at a value between a wavelength range corresponding to a green color and a wavelength range corresponding to a blue color. In addition, a cut-off wavelength of the surface 82 of the prism 80 is set at a value between a wavelength range corresponding to a red color and the wavelength range corresponding to the green color.

Meanwhile, the prism 70 combines the blue component light B and the combine light including the red component light R and the green component light G by means of the surface 72. The prism 80 combines the red component light R and the green component light G by means of the surface 82. In short, the prism 70 and the prism 80 function as a color combining element to combine color component light of all the colors.

The prism 90 is made of a light transmissive material, and includes a surface 91. The surface 91 is configured to transmit the green component light G. Here, the green component light G entering the DMD 500G and the green component light G outputted from the DMD 500G pass through the surface 91.

The DMD 500R, the DMD 500G and the DMD 500B are each formed of multiple movable micromirrors. Each of the micromirrors corresponds to one pixel, basically. The DMD 500R changes the angle of each micromirror to switch whether or not to reflect the red component light R toward the projection unit 150. Similarly, the DMD 500G and the DMD 500B change the angle of each micromirror to switch whether or not to reflect the green component light G and the blue component light B toward the projection unit 150, respectively.

The projection unit 150 includes a concave mirror 151 and a projection lens group 152.

The concave mirror 151 reflects the light (image light) outputted from the projection lens group 152. The concave mirror 151 collects the image light, and then scatters the image light over a wide angle. For example, the concave mirror 151 is an aspherical mirror having a surface concave toward the projection lens group 152.

The projection lens group 152 outputs the light (image light) outputted from the color separating-combining unit 140 to the concave mirror 152

### (Configuration of Control Unit)

A control unit according to the first embodiment will be described in detail by referring to the relevant drawing. FIG. 5 is a block diagram illustrating a control unit 600 according to the first embodiment. The control unit 600, which is included in the projection display apparatus 100, controls the projection display apparatus 100.

The control unit 600 converts image input signals into image output signals, and then outputs the image output signals thus created. Each of the image input signals corresponds to a frame, and contains a red input signal Rin, a green input signal Gin, and a blue input signal Bin. Likewise, each of the image input signals corresponds to a frame, and contains a red output signal Rout, a green output signal Gout, and a blue output signal Bout.

As FIG. 5 shows, the control unit 600 includes an image-signal receiver 610, an operation receiver 620, a valve controller 630, and a light-source controller 640.

The image-signal receiver 610 receives image input signals sent from an external device (not illustrated) such as a DVD player or a TV tuner.

The operation receiver 620 receives a drive-start command S_{START}, which is a command to start driving the projection display apparatus 100. The drive-start command S_{START} may be inputted through an operation I/F (not illustrated) or the like. Specifically, the drive-start command S_{START} is, for example, a command to power on the projection display apparatus 100 or a command to make the projection display apparatus 100 start displaying images. When receiving the drive-start command S_{START}, the operation receiver 620 in turn sends a drive-start command S_{START} to the valve controller 630.

In addition, the operation receiver 620 receives a drive-stop command S_{STOP}, which is a command to stop driving the projection display apparatus 100. The drive-stop command S_{STOP} may be inputted through an operation I/F (not illustrated) or the like. Specifically, the drive-stop command S_{STOP} is, for example, a command to power off the projection display apparatus 100 or a command to make the projection display apparatus 100 finish displaying images. When receiving the drive-stop command S_{STOP}, the operation receiver 620 in turn sends a drive-stop command S_{STOP} to the light-source controller 640.

When receiving an image input signal, the valve controller 630 starts controlling the DMDs 500 on the basis of the received image input signal. Specifically, the valve controller 630 controls the voltage to be applied to each of the micro mirrors on the basis of two predetermined values, and thereby the angle of each micro mirror is adjusted on the basis of the two predetermined values.

Specifically, the valve controller 630 controls the voltage to be applied to each micro mirror on the basis of the two predetermined values: a first voltage; and a second voltage which is lower than the first voltage. Thereby, the valve controller 630 adjusts the angle of each micro mirror on the basis of the two predetermined values.

In this embodiment, the valve controller 630 starts initializing the DMDs 500 in response to a drive-start command S_{START}. Specifically, upon receiving a drive-start command S_{START}, the valve controller 630 applies a predetermined voltage to each micro mirror so that the micro mirrors included in the DMDs 500 can be oriented at a predetermined angle. The above-mentioned predetermined voltage may be either the first voltage or the second voltage. Alternatively, the predetermined voltage may a voltage that is different from any of the first voltage and from the second voltage. Thus, the DMDs 500 are made ready to reflect the incident light beams in a direction so that none of the members situated around the DMDs 500 blocks the optical paths of the reflected light beams.

Once finishing the initialization of the DMDs 500, the valve controller 630 sends, to the light-source controller 640, a valve-initialization completion notification E_{START} which is a notification indicating that the initialization of the DMDs 500 has been completed.

In addition, the valve controller 630 finishes the control on the DMDs 500 in response to a light-source turning-off notification L_{STOP} sent from the light-source controller 640. Specifically, upon receiving the light-source turning-off notification L_{STOP}, the valve controller 630 stops applying the voltage to each of the plural micro mirrors included in the DMDs 500. The control on the angles of the micro mirrors is thus cancelled, and the micro mirrors are thus left swingable with vibrations and/or the tilting of the DMDs 500.

The light-source controller 640 controls each of the plural solid light sources 111 included in the light-source unit 110. Specifically, the light-source controller 640 controls the voltage to be applied to each of the solid light sources 111 so as to control the amount of light to be emitted from each of the solid light sources 111.

In this embodiment, once the valve controller 630 finishes the initialization of the DMDs 500, the light-source controller 640 makes the light-source unit 110 start operating. Specifically, upon receiving a valve-initialization completion notification E_{START} from the valve controller 630, the light-source controller 640 starts applying a voltage to the solid light sources 111. Thus, the solid light sources 111 start lighting, and the light beams emitted from the solid light sources 111 enter the corresponding one of the DMDs 500.

In addition, the light-source controller 640 makes the solid light sources 111 stop operating in response to a drive-stop command S_{STOP}. Specifically, upon receiving a drive-stop command S_{STOP}, the light-source controller 640 stops applying the voltage to the solid light sources 111. Thus, the control on the solid light sources 111 is finished, and the solid light sources 111 stop lighting.

Once the solid light sources 111 stop lighting, the light-source controller 640 sends a light-source turning-off notification L_{STOP}, which is a notification indicating that the solid light sources 111 have stopped lighting.

### (Operation of Control Unit)

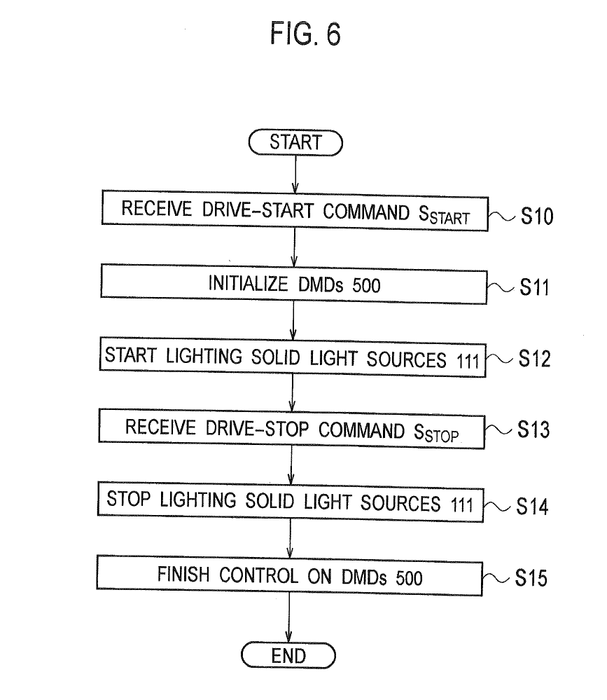

An operation of the control unit 600 according to the first embodiment will be described below by referring to the relevant drawing. FIG. 6 is a flowchart illustrating the operation of the control unit 600 according to the first embodiment.

At step S10, the control unit 600 receives a drive-start command S_{START}.

At step S11, the control unit 600 initializes the DMDs 500. Specifically, the control unit 600 applies a predetermined voltage to each of the micro mirrors included in the DMDs 500, and thus orients all of the micro mirrors at the same predetermined angle.

At step S12, the control unit 600 makes the solid light sources 111 start lighting.

At step S13, the control unit 600 receives a drive-stop command S_{STOP}.

At step S14, the control unit 600 makes the solid light sources 111 stop lighting.

At step S15, the control unit 600 finishes the control on the DMDs 500. Specifically, the control unit 600 stops applying the voltage to the micro mirrors included in the DMDs 500.

### (Advantageous Effects)

In the first embodiment, the projection display apparatus 100 includes the DMDs 500 serving as a light valve. The DMDs 500 include plural micro mirrors. By applying a voltage to each of the micro mirrors on the basis of the two predetermined values, the angle of each micro mirror is adjusted on the basis of the two predetermined values.

If, however, the DMDs 500 are not controlled by the valve controller 630, the angles of the micro mirrors are not adjusted. In this case, the light beams emitted from the solid light sources 111 are reflected by the micro mirrors in uncontrolled various directions. Consequently, the members situated around the DMDs 500 are heated by the light beams reflected from the DMDs 500, and therefore may have a problem (such as deformation or breakage).

Accordingly, in the first embodiment, the light-source controller 640 makes the solid light sources 111 start operating after the valve controller 630 finishes the initialization of the DMDs 500.

Thus, the light beams emitted from the solid light sources 111 can enter the DMDs 500 after each of the micro mirrors included in the DMDs 500 is oriented at a predetermined angle. This prevents the light beams emitted from the solid light sources 111 from being reflected in uncontrolled various directions. In this way, emission of undesired light beams from the DMDs 500 can be avoided. Thus, it is possible to inhibit the members situated around the DMDs 500 from having a trouble due to the heating of the members by uncontrolled light beams reflected from the DMDs 500.

In addition, in the first embodiment, the valve controller 630 makes the DMDs 500 stop operating after the light-source controller 640 makes the solid light sources 111 stop lighting.

Accordingly, the application of voltages to the micro mirrors is finished after the light beams entering the DMDs 500 are switched off. So, at the moment when the solid light sources 111 stop lighting, the micro mirrors are still arranged in the predetermined directions. This prevents the light beams emitted from the solid light sources 111 from being reflected in uncontrolled various directions. To put it differently, emission of undesired light beams from the DMDs 500 can be avoided. Consequently, the members situated around the DMDs 500 can be more effectively prevented from having a trouble due to the heating of the members by uncontrolled light beams reflected from the DMDs 500.

### Second Embodiment

A second embodiment of the invention will be described below by referring to the relevant drawings. The following description focuses mainly on the differences that the second embodiment has with the first embodiment.

Specifically, the timing at which the cooling unit 130 starts operating will be described in detail in the second embodiment, though no description concerning this point has been given in the first embodiment.

### (Configuration of Control Unit)

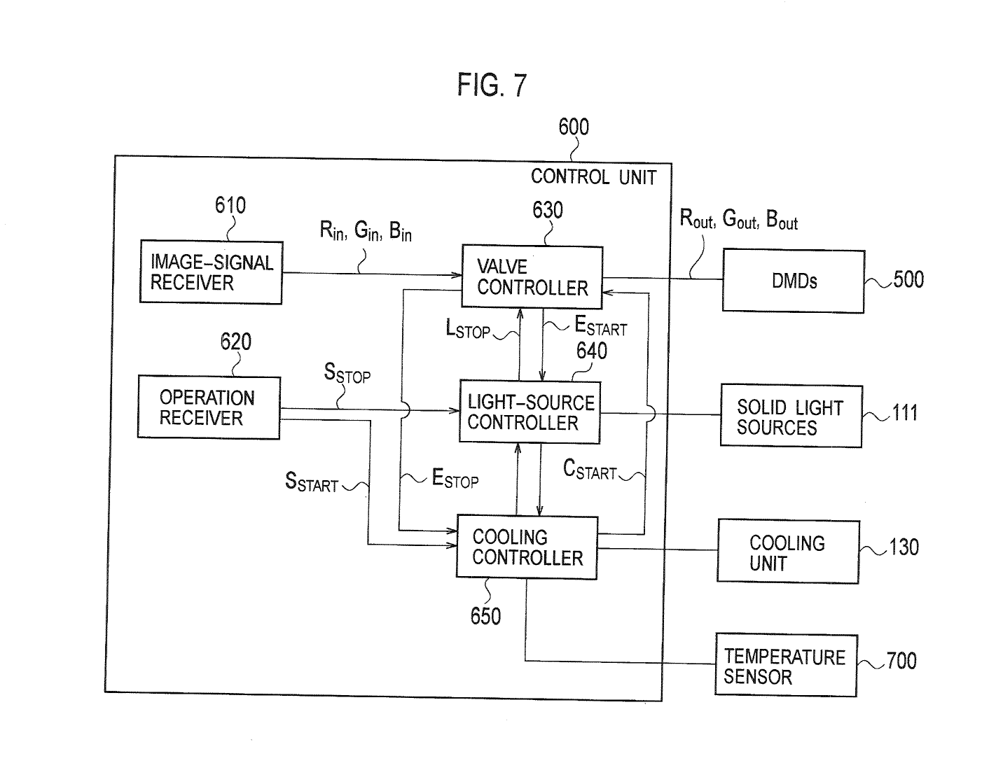

A control unit according to the second embodiment will be described in detail by referring to the relevant drawing. FIG. 7 is a block diagram illustrating a control unit 600 according to the second embodiment.

As FIG. 7 shows, the control unit 600 includes a cooling controller 650 as well as the image-signal receiver 610, the operation receiver 620, the valve controller 630, and the light-source controller 640.

The operation receiver 620 sends a drive-start command S_{START} to the cooling controller 650.

The cooling controller 650 controls the cooling unit 130, which adjusts the temperature of each of the solid light sources 111. Specifically, the cooling controller 650 supplies electric power to the cooling unit 130, and thus makes a refrigerant circulate in the cooling jackets 131.

The cooling controller 650 is connected to a temperature sensor 700 that detects both the surface temperature of each of the solid light sources 111 and the surface temperature of the DMDs 500. The cooling controller 650 acquires, from the temperature sensor 700, both the detected surface temperature of each of the solid light sources 111 and the detected surface temperature of the DMDs 500. The surface temperature of each of the solid light sources 111 is an example of an “indicator temperature,” that is, an indicator of the temperature of each of the solid light sources 111.

The cooling controller 650 makes the cooling unit 130 start operating in response to a drive-start command S_{START}. Specifically, upon receiving a drive-start command S_{START}, the cooling controller 650 supplies electric power to the cooling unit 130, and thus stars the supply of the refrigerant to the cooling jackets 131.

Once the cooling unit 130 starts operating, the cooling controller 650 acquires the surface temperature of each of the solid light sources 111 from the temperature sensor 700 so as to check that the surface temperature of each of the solid light sources 111 is within an appropriate temperature range for the solid light sources 111 to start operating. In addition, once the cooling unit 130 starts operating, the cooling controller 650 acquires the surface temperature of the DMDs 500 from the temperature sensor 700 so as to check that the surface temperature of the DMDs 500 is within an appropriate temperature range for the DMDs 500 to start operating.

Once the cooling controller 650 makes sure that the surface temperature of each of the solid light sources 111 and the surface temperature of the DMDs 500 are within their respective predetermined temperature ranges, the cooling controller 650 sends, to the valve controller 630, an operation-start-preparation completion notification C_{START} indicating that the solid light sources 111 and the DMDs 500 are ready to start their operations.

In addition, once the valve controller 630 finishes the control on the DMDs 500, the cooling controller 650 makes the cooling unit 130 stop operating. Specifically, upon receiving a valve-stop completion notification E_{STOP} sent from the valve controller 630 (details of this valve-stop completion notification E_{STOP} will be described later), the cooling controller 650 stop supplying the electric power to the cooling unit 130, and thus makes the refrigerant stop circulating in the cooling jackets 131.

In this embodiment, the valve controller 630 starts initializing the DMDs 500 after the cooling controller 650 makes the cooling unit 130 start operating. Specifically, upon receiving an operation-start-preparation completion notification C_{START} from the cooling controller 650, the valve controller 630 applies a predetermined voltage to each of the micro mirrors, and thus orients the micro mirrors included in the DMD 500 in predetermined directions.

In addition, once the valve controller 630 finishes the control on the DMDs 500 in response to a light-source turning-off notification L_{STOP} sent from the light-source controller 640, the valve controller 630 sends, to the cooling controller 650, a valve-stop completion notification E_{STOP} indicating that the control on the DMDs 500 has been finished.

As in the case of the first embodiment, the light-source controller 640 of this second embodiment makes the solid light sources 111 start lighting in response to an operation-start-preparation completion notification E_{START}, and makes the solid light sources 111 stop lighting in response to a drive-stop command S_{STOP}. Once the solid light sources 111 stop lighting, the light-source controller 640 sends a light-source turning-off notification L_{STOP} to the valve controller 630.

### (Operation of Control Unit)

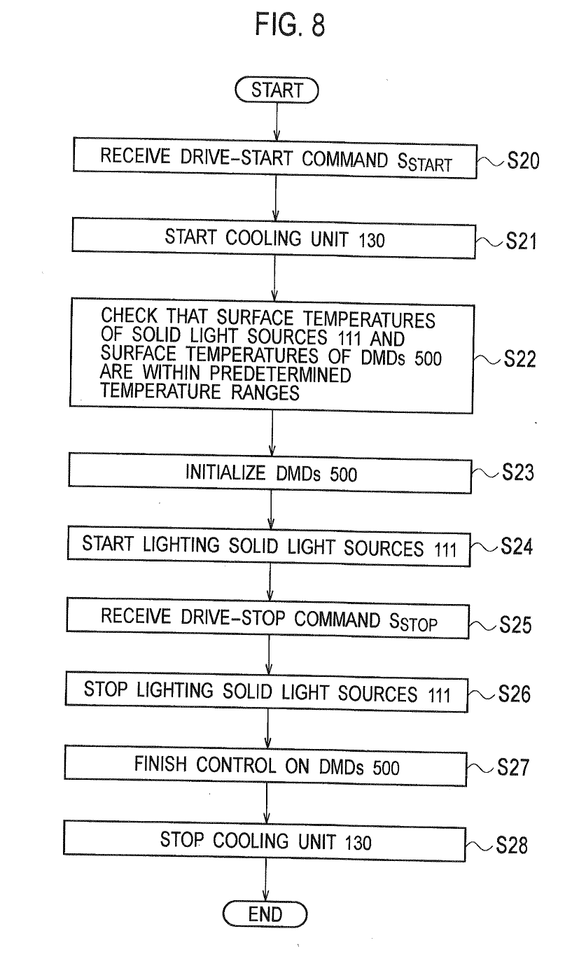

An operation of the control unit according to the second embodiment will be described below by referring to the relevant drawing. FIG. 8 is a flowchart illustrating the operation of the control unit 600 according to the second embodiment.

At step S20, the control unit 600 receives a drive-start command S_{START}.

At step S21, the control unit 600 makes the cooling unit 130 start operating.

At step S22, the control unit 600 makes sure that both the surface temperature of each of the solid light sources 111 and the surface temperature of the DMDs 500 are within their respective predetermined temperature ranges.

At step S23, the control unit 600 initializes the DMDs 500. At step S24, the control unit 600 makes the solid light sources 111 start lighting.

At step S25, the control unit 600 receives a drive-stop command S_{STOP}.

At step S26, the control unit 600 makes the solid light sources 111 stop lighting.

At step S27, the control unit 600 finishes the control on the DMDs 500.

At step S28, the control unit 600 makes the cooling unit 130 stop operating.

### (Advantageous Effects)

In the second embodiment, the light-source controller 640 makes the solid light sources 111 start operating after the cooling controller 650 makes the cooling unit 130 start operating.

Accordingly, the solid light sources 111 start lighting after the cooling unit 130 starts operating. In this case, it is possible to more effectively inhibit the solid light sources 111 from deteriorating due to heating, than in the case where the solid light sources 111 start lighting before the cooling unit 130 starts operating.

In addition, in the second embodiment, the valve controller 630 initializes the DMDs 500 after the control unit 600 makes sure that the temperature of the DMDs 500 is within the appropriate temperature range. Accordingly, in this case, it is possible to more effectively inhibit the DMDs 500 from deteriorating due to the heating, than in the case where the DMDs 500 are initialized before the temperature of the DMDs 500 is still out of the appropriate temperature range.

In addition, in the second embodiment, the light-source controller 640 makes the solid light sources 111 start operating after the cooling controller 650 makes sure that the temperature of each of the solid light sources 111 is within the appropriate temperature range. Accordingly, in this case, it is possible to more effectively inhibit the solid light sources 111 from deteriorating due to the heating, than in the case where the solid light sources 111 start operating before the temperature of each of the solid light sources 111 is still out of the appropriate temperature range.

In addition, in second embodiment, the cooling controller 650 makes the cooling unit 130 stop operating after the light-source controller 640 makes the solid light sources 111 stop lighting.

Accordingly, the cooling unit 130 stops operating after the solid light sources 111 stop emitting the light beams to enter the DMDs 500. Accordingly, in this case, it is possible to more effectively inhibit the solid light sources 111 from deteriorating due to the heating, than in the case where the cooling unit 130 stops operating before the solid light sources 111 stop lighting.

In addition, in the second embodiment, the cooling controller 650 makes the cooling unit 130 stop operating after the valve controller 630 finishes the control on the DMDs 500. Accordingly, in this case, it is possible to more effectively inhibit the DMDs 500 from deteriorating due to the heating, than in the case where the cooling unit 130 stops operating before the control on the DMDs 500 is finished.

### Third Embodiment

A third embodiment of the invention will be described below by referring to the relevant drawings. The following description focuses mainly on the differences that the third embodiment has with the first embodiment.

Specifically, a projection display apparatus of the third embodiment is capable of detecting an intruding object (e.g., a human body) on the optical passage of the light beams emitted from the projection unit, though no description concerning this point has been given in the first embodiment.

### (Configuration of Control Unit)

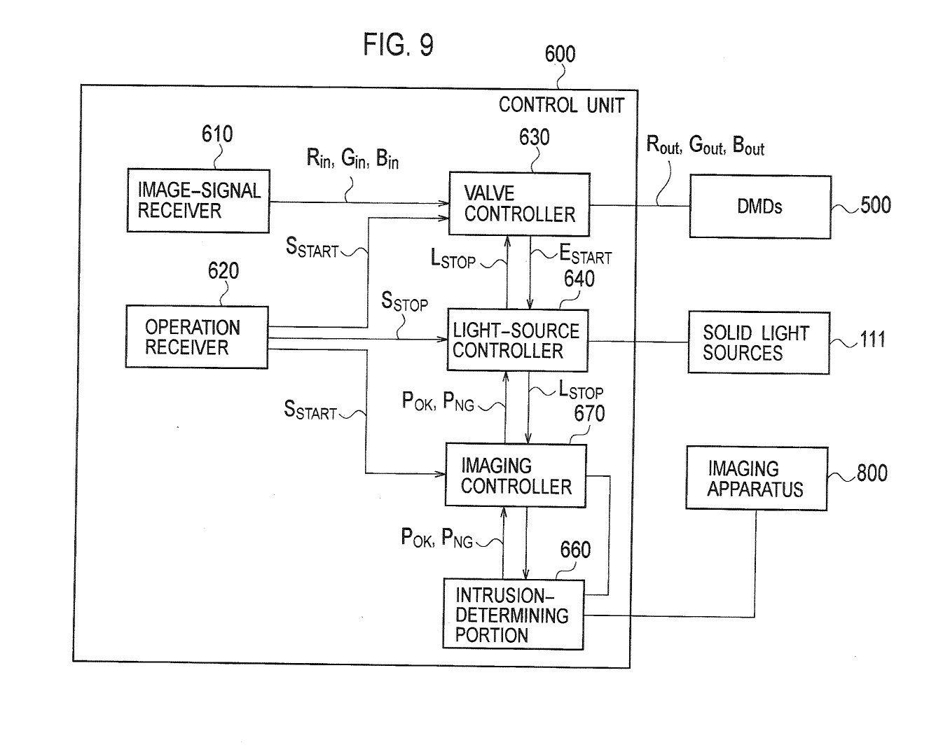

A control unit according to the third embodiment will be described in detail by referring to the relevant drawing. FIG. 9 is a block diagram illustrating a control unit 600 according to the third embodiment.

As FIG. 9 shows, the control unit 600 includes an intrusion-determining portion 660 and an imaging controller 670 as well as the image-signal receiver 610, the operation receiver 620, the valve controller 630, and the light-source controller 640.

The intrusion-determining portion 660 is connected to an imaging apparatus 800 configured to take images of the projection surface 300. Where the imaging apparatus 800 is positioned and how wide the view angle of the imaging apparatus 800 has are determined so that the imaging apparatus 800 can take images of the optical passage of the light beams emitted from the projection unit 150.

The imaging apparatus 800 may be either incorporated into the projection display apparatus 100 or provided as a body that is different from the projection display apparatus 100. In addition, there may be provided one or more imaging apparatuses 800.

For instance, if only a single imaging apparatus 800 is provided, the single imaging apparatus 800 is situated substantially at the center in the width direction of the casing 200. In this case, the view angle of the single imaging apparatus 800 is preferably substantially equal to the angle at which the light beams emitted from the projection unit 150 spread.

If two imaging apparatuses 800 are provided, the imaging apparatuses 800 are situated respectively at the two end portions in the width direction of the casing 200. In this case, it is preferable that spaces (imaging spaces) the images of which can be respectively taken by the two imaging apparatuses 800 overlap partially each other.

On the basis of the image taken by each imaging apparatus 800, the intrusion-determining portion 660 determines, at least, whether or not there is an intruding object (e.g., a human body) on the optical passage of the light beams emitted from the projection unit 150. The intrusion-determining portion 660 may determine whether or not there is an intruding object not only on the optical passage of the light beams emitted from the projection unit 150 but also in a space near the optical passage of the light beams emitted from the projection unit 150. To put it differently, the intrusion-determining portion 660 may determine whether or not there is an intruding object within a certain area including the optical passage.

As a method of determining whether or not there is an intruding object (e.g., a human body), the background difference method or the frame difference method is conceivable. According to the background difference method, whether or not there an intruding object is determined on the basis of the differences between the background image that has been acquired beforehand and the image taken by the imaging apparatus 800. According to the frame difference method, whether or not there is an intruding object is determined on the basis of the difference between two temporally consecutive images taken by the imaging apparatus 800.

When determining that there is no intruding object on the optical passage of the light beams emitted from the projection unit 150, the intrusion-determining portion 660 sends, to the imaging controller 670, a passage-cleared notification P_{OK} indicating that there is no intruding object on the optical passage. In contrast, when determining that there is an intruding object on the optical passage of the light beams emitted from the projection unit 150, the intrusion-determining portion 660 sends, to the imaging controller 670, a passage-uncleared notification P_{NG} indicating that there is an intruding object on the optical passage.

The imaging controller 670 makes the intrusion-determining portion 660 start operating in response to a drive-start command S_{START}. With the drive-start command S_{START}, the intrusion-determining portion 660 starts the determination processing.

In this embodiment, the imaging controller 670 forwards, to the light-source controller 640, either the passage-cleared notification P_{OK} or the passage-uncleared notification P_{NG} received from the intrusion-determining portion 660.

In addition, upon receiving a light-source turning-off notification L_{STOP} from the light-source controller 640, the imaging controller 670 makes the intrusion-determining portion 660 stop operating. With the light-source turning-off notification L_{STOP}, the intrusion-determining portion 660 finishes the determination processing.

When the determination by the intrusion-determining portion 660 determines that there is no intruding object on the optical passage of the light beams emitted from the projection unit 150, the light-source controller 640 makes the light-source unit 110 start operating. Specifically, upon receiving a passage-cleared notification P_{OK} from the imaging controller 670, the light-source controller 640 starts applying a voltage to the solid light sources 111.

To put it differently, the light-source controller 640 of the third embodiment makes the light-source unit 110 start operating upon receiving both the passage-cleared notification P_{OK} and the valve-initialization completion notification E_{START}.

In addition, when making the solid light sources 111 stop lighting, the light-source controller 640 sends, to the imaging controller 670, a light-source turning-off notification L_{STOP} which is a notification indicating that the solid light sources 111 have stopped lighting.

To put it differently, the light-source controller 640 of the third embodiment notifies not only the valve controller 630 but also the imaging controller 670 that the solid light sources 111 have stopped lighting.

In addition, upon receiving the passage-uncleared notification P_{NG} from the imaging controller 670, the light-source controller 640 reduces the voltage to be applied to the solid light sources 111. Thus, the light-source controller 640 reduces the amount of light to be emitted from the solid light sources 111.

### (Operation of Control Unit)

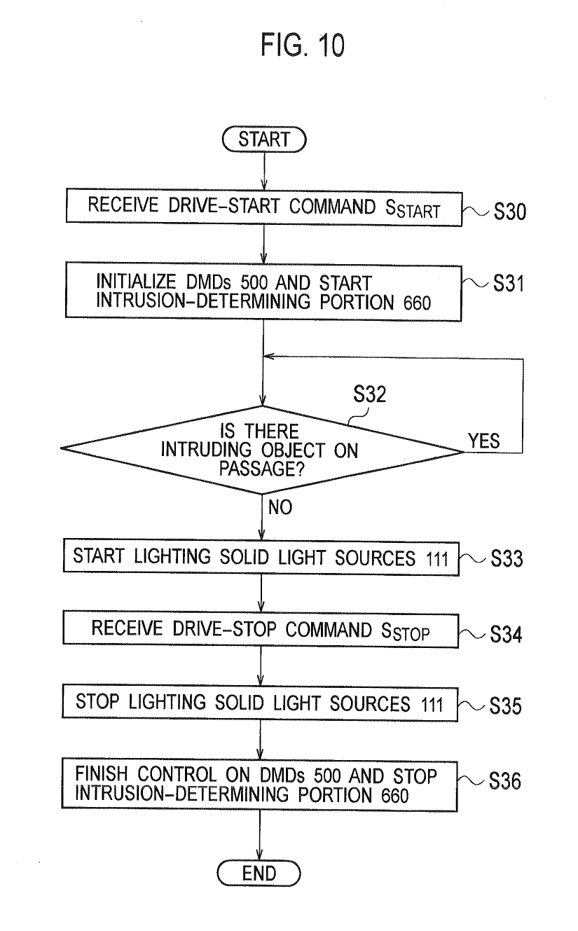

An operation of the control unit 600 according to the third embodiment will be described below by referring to the relevant drawing. FIG. 10 is a flowchart illustrating the operation of the control unit 600 according to the third embodiment.

At step S30, the control unit 600 receives a drive-start command S_{START}.

At step S31, the control unit 600 initializes the DMDs 500 and makes the intrusion-determining portion 660 start operating.

At step S32, the control unit 600 determines whether or not there is an intruding object (e.g., a human body) on the optical passage of the light beams emitted from the projection unit 150. If it is determined that there is no intruding object on the optical passage, the control unit 600 proceeds on to the processing at step S33. If it is determined that there is an intruding object on the optical passage, the control unit 600 repeats the processing at step S32.

At step S33, the control unit 600 makes the solid light sources 111 start lighting.

At step S34, the control unit 600 receives a drive-stop command S_{STOP}.

At step S35, the control unit 600 makes the solid light sources 111 stop lighting.

At step S36, the control unit 600 finishes the control on the DMDs 500, and makes the intrusion-determining portion 660 stop operating.

### (Advantageous Effects)

In the third embodiment, the light-source controller 640 makes the light-source unit 110 start operating after the intrusion-determining portion 660 determines that there is no intruding object on the optical passage of the light beams emitted from the projection unit 150.

Accordingly, the solid light sources 111 start lighting on condition that there is no intruding human body on the optical passage. Consequently, it is possible to inhibit a person who enters the projection area from being irradiated with the light emitted from the projection unit 150.

### Fourth Embodiment

A fourth embodiment of the invention will be described below by referring to the relevant drawings. The following description focuses mainly on the differences that the fourth embodiment has with the first embodiment.

Specifically, the projection display apparatus of the fourth embodiment includes a light-blocking shutter provided at the light-emitting side of the light source, though no description concerning this point has been given in the first embodiment.

### (Configurations of Color Separation-Synthesis Unit and Projection Unit)

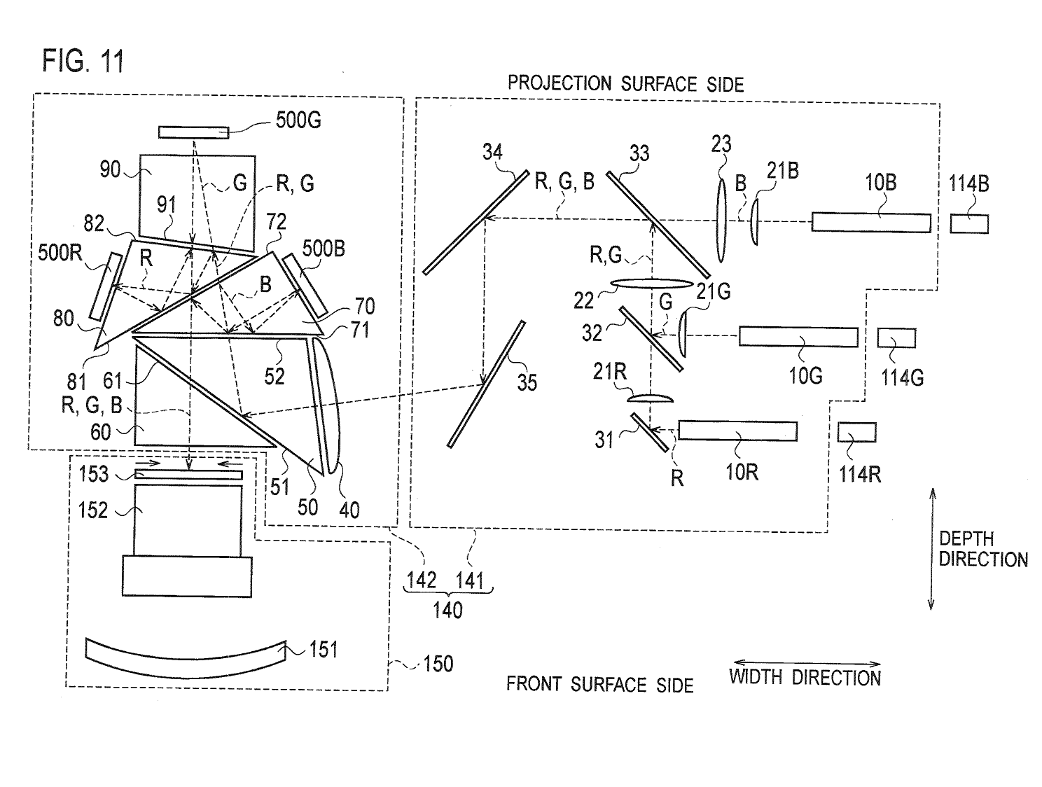

A configuration of a color separation-synthesis unit and a configuration of a projection unit according to the fourth embodiment will be described in detail by referring to the relevant drawing. FIG. 11 is a diagram illustrating a projection unit 150 according to the fourth embodiment.

As FIG. 11 shows, the projection unit 150 includes a light-blocking shutter 153 as well as the concave mirror 151 and the projection lenses 152.

The light-blocking shutter 153 is situated at the light-entering side of the projection lenses 152. If the light-blocking shutter 153 is closed, the light beams emitted from the second unit 142 are blocked by the light-blocking shutter 153. If the light-blocking shutter 153 is opened, the light beams emitted from the second unit 142 are led to the projection lenses 152.

The light-blocking shutter 153 is closed when the projection unit 150 is in an initialized state. After the initialization, the light-blocking shutter 153 is opened when the image light is projected onto the projection surface 300.

### (Configuration of Control Unit)

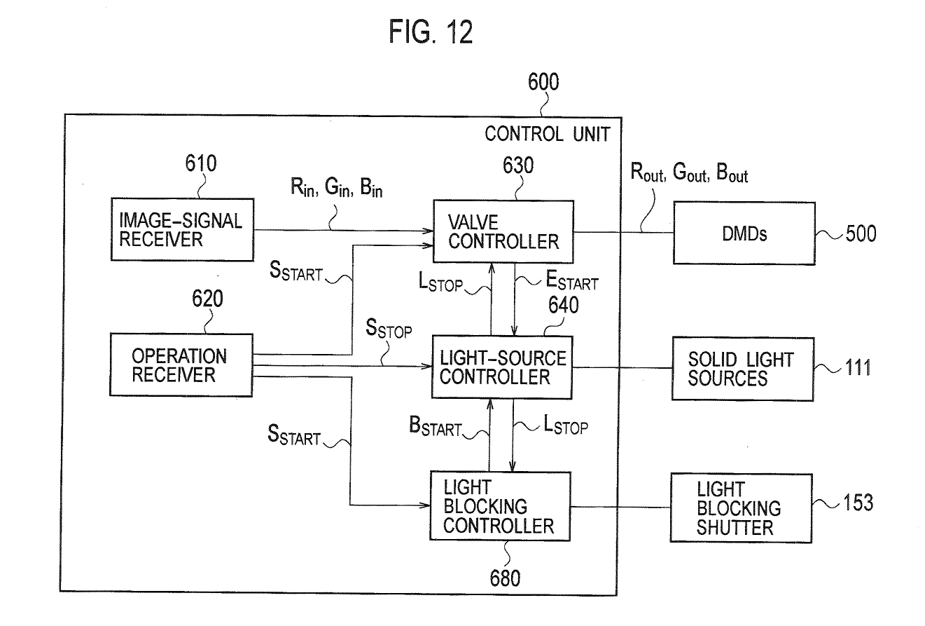

A control unit according to the fourth embodiment will be described in detail by referring to the relevant drawing. FIG. 12 is a block diagram illustrating a control unit 600 according to the fourth embodiment.

As FIG. 12 shows, the control unit 600 includes a light-blocking controller 680 as well as the image-signal receiver 610, the operation receiver 620, the valve controller 630, and the light-source controller 640.

The light-blocking controller 680 controls the opening and the closing of the light-blocking shutter 153. Firstly, the light-blocking controller 680 initializes the light-blocking shutter 153 in response to a drive-start command S_{START}. The light-blocking controller 680 initializes the light-blocking shutter 153 by closing the light-blocking shutter 153. Then, the light-blocking controller 680 opens the light-blocking shutter 153 if an image output signal is inputted into the DMDs 500.

When finishing the initialization of the light-blocking shutter 153 by closing the light-blocking shutter 153, the light-blocking controller 680 sends, to the light-source controller 640, a light-blocking initialization completion notification B_{START} indicating that the initialization of the light-blocking shutter 153 has been finished.

In addition, upon receiving a light-source turning-off notification L_{STOP} from the light-source controller 640, the light-blocking controller 680 finishes the control to open and close the light-blocking shutter 153.

Once the light-blocking controller 680 initializes the light-blocking shutter 153, the light-source controller 640 makes the light-source unit 110 start operating. Specifically, upon receiving a light-blocking initialization completion notification B_{START} from the light-blocking controller 680, the light-source controller 640 starts applying a voltage to the solid light sources 111.

In addition, when making the solid light sources 111 stop lighting, the light-source controller 640 sends, to the light-blocking controller 680, a light-source turning-off notification L_{STOP} indicating that the solid light sources 111 have stopped lighting.

To put it differently, the light-source controller 640 of the fourth embodiment notifies not only the valve controller 630 but also the light-blocking controller 680 that the solid light sources 111 have stopped lighting.

### (Operation of Control Unit)

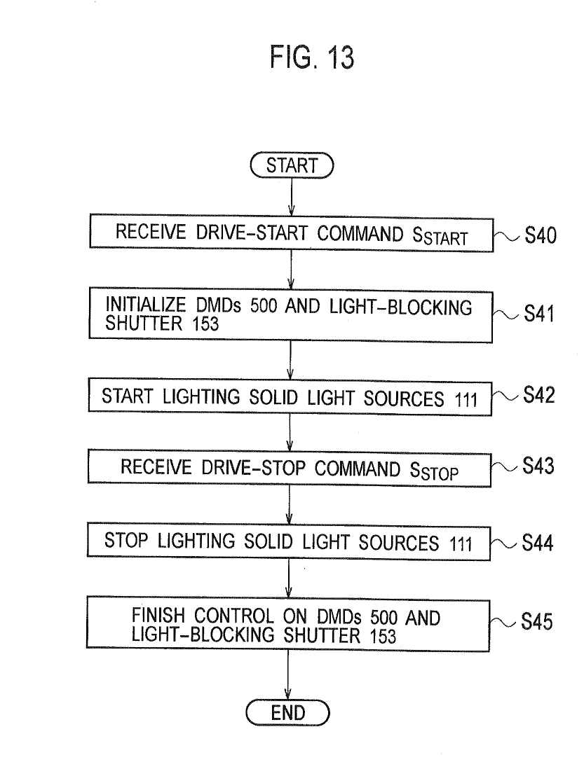

An operation of the control unit 600 according to the fourth embodiment will be described below by referring to the relevant drawing. FIG. 13 is a flowchart illustrating the operation of the control unit 600 according to the fourth embodiment.

At step S40, the control unit 600 receives a drive-start command S_{START}.

At step S41, the control unit 600 initializes the DMDs 500, and also initializes the light-blocking shutter 153 by closing the light-blocking shutter 153.

At step S42, the control unit 600 makes the solid light sources 111 start lighting.

At step S43, the control unit 600 receives a drive-stop command S_{STOP}.

At step S44, the control unit 600 makes the solid light sources 111 stop lighting.

At step S45, the control unit 600 finishes the control on the DMDs 500, and also finishes the control of the light-blocking shutter 153.

### (Advantageous Effects)

In the fourth embodiment, the light-source controller 640 makes the solid light sources 111 start operating after the light-blocking controller 680 finishes the initialization of the light-blocking shutter 153. The light-blocking controller 680 initializes the light-blocking shutter 153 by closing the light-blocking shutter 153.

Accordingly, the solid light sources 111 start lighting after the light-blocking shutter 153 is closed. Consequently, unnecessary irradiation of the projection surface 300 is more effectively prevented than in the case where the solid light sources 111 start lighting before the light-blocking shutter 153 is closed.

### Other Embodiments

As described above, the details of the present invention have been disclosed by using the embodiments of the present invention. However, it should not be understood that the description and drawings which constitute part of this disclosure limit the present invention. From this disclosure, various alternative embodiments, examples, and operation techniques will be easily found by those skilled in the art.

The foregoing descriptions of the embodiments are based on a case where the DMDs 500 are used as the light valve. The invention, however, is not limited to such a case. For instance, various light valves of different kinds may be used in place of the DMDs. Some examples of the usable light valves are: reflection-type light valves, such as reflective liquid crystal displays (LCDs); and transmissive light valves, such as transmissive LCDs. When these types of light valves are used, the following problems may occur. When a reflective LCD is used, the reflective LCD that is not initialized may reflect most of the incident light. When a transmissive LCD is used, the transmissive LCD that is not initialized may emit light without adjusting the amount of incident light. In these cases, if the solid light sources are made to start lighting before the initialization of the light valve is finished, the projection surface is illuminated to the extent that the user may feel too bright. The invention, if employed in such cases, can inhibit the light valve from emitting undesired light beams because the light valve can be initialized before the light valve receives the incident light emitted from the solid light source.

In addition, the foregoing descriptions of the embodiments are based on a case where the cooling unit 130 is used as a “temperature adjuster.” The invention, however, is not limited to such a case. If the projection display apparatus 100 is used in a cold environment, the “temperature adjuster” may be provided as a heating unit with a heating medium circulating in the unit. If the temperature of each of the solid light sources 111 and the temperature of the DMDs 500 are lower than their respective appropriate temperatures, the operation of each of the solid light sources 111 and the operation of the DMDs 500 may become unstable. The use of the heating unit, however, can inhibit such unstable operations from occurring.

In addition, the cooling jackets 131 in the above-described embodiments each have a passage through which a refrigerant circulates. The invention, however, is not limited to such a form of the cooling jackets 131. For instance, the cooling jackets 131 may be provided as a form of a thermoelectric transducer (e.g., a Peltier cooling element).

In addition, the temperature sensor 700 of the second embodiment detects the surface temperature of each of the solid light sources 111 as an exemplar “indicator temperature” that indicates the temperature of each of the solid light sources 111 per se. Alternatively, the internal temperature of each of the solid light sources 111 may be detected in place of the surface temperature. Still alternatively, as the “indicator temperature” that indicates the temperature of each of the solid light sources 111 per se, the temperature sensor 700 may detect the temperature of the refrigerant supplied to the cooling jackets 131. In this case, the cooling controller 650 must make sure that the temperature of the refrigerant is stable within a predetermined temperature range.

In addition, in the third embodiment, the intrusion-determining portion 660 determines whether or not there is an intruding object. The invention, however, is not limited to such a case. The intrusion-determining portion 660 may determine whether or not there is an intruding object on the basis of a result of detection by a laser distance sensor.

In addition, though not specifically mentioned in the third embodiment, the imaging apparatus 800 may be provided as an infrared sensor that takes thermal images by detecting the infrared rays or may be provided as a CCD camera that takes visible-light images by detecting the visible-light rays.

In addition, though not specifically mentioned in the third embodiment, the projection display apparatus 100 may be configured to sound an alarm if an intruding object is detected on the optical passage of the light beams emitted from the projection unit 150.

In addition, the light-blocking shutter 153 of the fourth embodiment is situated at the light-entering side of the projection lenses 152. The invention, however, is not limited to such a case. What is necessary is providing the light-blocking shutter 153 at the light-emitting side of the solid light sources 111.

From this disclosure, various alternative embodiments, examples, and operation techniques will be easily found by those skilled in the art. Accordingly, the technical scope of the present invention should be determined only by the matters to define the invention in the scope of claims regarded as appropriate based on the description.

What is claimed is:

1. A projection display apparatus comprising:
a light source;
a light valve configured to modulate light emitted from the light source;
a projection unit configured to project light emitted from the light valve, on a projection surface;
a valve controller configured to initialize the light valve in response to a drive-starting command to start driving the projection display apparatus; and
a light-source controller configured to make the light source start operating when the valve controller finishes initialization of the light valve.

2. The projection display apparatus according to claim 1 further comprising:
a temperature adjuster configured to adjust a temperature of the light source;
a temperature-adjustor controller configured to make the temperature adjustor start operating in response to the drive-starting command; and
a temperature sensor configured to detect an indicator temperature that is used as an indicator for the temperature of the light source, wherein
the light-source controller makes the light source start operating on condition that the indicator temperature detected by the temperature sensor is within a predetermined temperature range.

3. The projection display apparatus according to claim 2, wherein
the temperature adjustor includes a coolant jacket in which a liquid medium circulates and which is attached to the light source, and
the temperature sensor detects a temperature of the liquid medium supplied to the coolant jacket, as the indicator temperature.

4. The projection display apparatus according to claim 1, further comprising:
an intrusion-determining portion configured to determine whether or not an intruding object exists on or near an optical passage of light emitted from the projection unit, wherein
when the intrusion-determining portion determines that no intruding object exists on or near the optical passage, the light-source controller makes the light source start operating.

5. The projection display apparatus according to claim 1 further comprising:
a light-blocking shutter provided at a light-emitting side of the light source; and
a light-blocking-shutter controller configured to initialize the light-blocking shutter by closing the light-blocking shutter in response to the drive-start command, wherein
when the light-blocking-shutter controller finishes initialization of the light-blocking shutter, the light-source controller makes the light source start operating.
